(19) United States
(12) Patent Application Publication
(10) Pub. No.: US 2017/0185922 A1
(43) Pub. Date: Jun. 29, 2017

(54) Hierarchical Capital Allocation Using Clustered Machine Learning

(71) Applicants: Jeffrey S. Lange, Chicago, IL (US); Marcos López de Prado, Harrison, NY (US)

(72) Inventors: Jeffrey S. Lange, Chicago, IL (US); Marcos López de Prado, Harrison, NY (US)

(21) Appl. No.: 15/391,764

(22) Filed: Dec. 27, 2016

Related U.S. Application Data
(60) Provisional application No. 62/272,302, filed on Dec. 29, 2015.

(51) Int. Cl. G06N 99/00; G06F 17/16; H04L 29/08

(52) U.S. Cl. CPC G06N 99/005; H04L 67/10; G06F 17/16

(57) ABSTRACT

A cluster of server computing devices receives a matrix of observations and divides the matrix into a plurality of input data sets. Each processor in the cluster generates a first data structure for a distance matrix based upon a corresponding input data set, the distance matrix comprising a plurality of items, and clusters the items to generate a clustered distance matrix. Each processor generates a second data structure for a linkage matrix using the clustered matrix. Each processor analyzes the linkage matrix to determine a number of items per cluster and analyzes the linkage matrix to assign a weight to each cluster based upon a distance of the cluster to other clusters and a size of the cluster. Each processor generates a third data structure containing the clusters and assigned weights. Each third data structure is consolidated into a hierarchical data structure, which is transmitted to a remote computing device.

### RELATED APPLICATIONS

This application claims priority to U.S. Provisional Patent Application No. 62/272,302, filed on Dec. 29, 2015, the entirety of which is incorporated herein by reference.

### TECHNICAL FIELD

This subject matter of this application relates generally to methods and apparatuses, including computer program products, for generating optimized portfolio allocation strategies using clustered machine learning to implement a hierarchical capital allocation structure. In particular, the methods and systems described herein provide a solution to the problem of generating outperformance out-of-sample, as opposed to the standard approach of optimizing performance in-sample.

### BACKGROUND

Portfolio construction is perhaps the most recurrent financial problem. On a daily basis, investment managers must build portfolios that incorporate their views and forecasts on risks and returns. This is the primordial question that twenty-four year-old Harry Markowitz attempted to answer more than sixty years ago. His monumental insight was to recognize that various levels of risk are associated with different “optimal” portfolios in terms of risk-adjusted returns, hence the notion of “efficient frontier” as described in Markowitz, H., “Portfolio selection,” Journal of Finance, Vol. 7 (1952), pp. 77-91. The implication was that it is rarely optimal to allocate all the capital to the investments with highest expected returns. Instead, we should take into account the correlations across alternative investments in order to build a diversified portfolio.

Before earning his Ph.D. in 1954, Markowitz left academia to work for the RAND Corporation, where he developed the Critical Line Algorithm (CLA). CLA is a quadratic optimization procedure specifically designed for inequality-constrained portfolio optimization problems, using the then recently discovered Karush-Kuhn-Tucker conditions as described in Kuhn, H. W. and A. W. Tucker, “Nonlinear programming,” Proceeds of 2^{nd} Berkeley Symposium, Berkeley: University of California Press (1952), pp. 481-492. This algorithm is notable in that it guarantees that the exact solution is found after a known number of iterations. A description and open-source implementation of this algorithm can be found in Bailey, D. and M. Lopez de Prado, “An open-source implementation of the critical-line algorithm for portfolio optimization,” Algorithms, Vol. 6, No. 1 (2013), pp. 169-196 (available at http://ssm.com/abstract=2197616). Surprisingly, most financial practitioners still seem unaware of CLA, as they often rely on generic-purpose quadratic programming methods that do not guarantee the correct solution or a stopping time.

Despite of the brilliance of Markowitz's theory, a number of practical problems make CLA solutions somewhat unreliable. A major caveat is that small deviations in the forecasted returns cause CLA to produce very different portfolios, as described in Michaud, R., Efficient asset allocation: A practical guide to stock portfolio optimization and asset allocation, Boston: Harvard Business School Press (1998). In an attempt to reduce this weights' variance, some authors have opted for ignoring forecasted returns altogether and focus on the covariance matrix, leading to risk-based capital allocation approaches such as risk-parity—for example, as described in Jurczenko, E., Risk-Based and Factor Investing, Elsevier Science (2015). This improves but does not prevent the instability issues. The reason is, quadratic programming methods require the inversion of a positive-definite covariance matrix. This inversion is prone to large errors when the covariance matrix is numerically ill-conditioned, i.e. it has a high condition number—as described in Bailey, D. and M. López de Prado, “Balanced Baskets: A new approach to Trading and Hedging Risks,” Journal of Investment Strategies, Vol. 1, No. 4 (2012), pp. 21-62, (available at http://ssm.com/abstract=20166170). Sadly, the condition number will be high in the presence of highly correlated investments, causing the eigenvalues to be estimated with high variance. This is Markowitz's curse: Quadratic optimization is likely to fail precisely when we there is a greater need for finding a diversified portfolio.

Increasing the size of the covariance matrix will only make matters worse, as each covariance is estimated with fewer degrees of freedom. In general, we need at least ½ N(N+1) independent and identically distributed (IID) observations in order to estimate a covariance matrix of size N that is not singular. For example, estimating an invertible covariance matrix of size fifty requires at the very least five years' worth of daily IID data. As most investors know, correlation structures do not remain invariant over such long periods by any reasonable confidence level. The severity of these challenges is epitomized by the fact that even naïve (equally-weighted) portfolios have been shown to beat mean-variance and risk-based optimization in practice—for example, as described in De Miguel, V., L. Garlappi and R. Uppal, R., “Optimal versus naïve diversification: How inefficient is the 1/N portfolio strategy?,” Review of Financial Studies, Vol. 22 (2009), pp. 1915-1953.

These instability concerns have received substantial attention in recent years, as some have carefully detailed—such as Kolm, P., R. Tutuncu and F. Fabozzi, “60 years of portfolio optimization,” European Journal of Operational Research, Vol. 234, No. 2 (2010), pp. 356-371. Most alternatives attempt to achieve robustness by incorporating additional constraints (see Clarke, R., H. De Silva, and S. Thorley, “Portfolio constraints and the fundamental law of active management,” Financial Analysts Journal, Vol. 58 (2002), pp. 48-66), introducing Bayesian priors (see Black, F. and R. Litterman, “Global portfolio optimization,” Financial Analysts Journal, Vol. 48 (1992), pp. 28-43) or improving the numerical stability of the covariance matrix's inverse (see Ledoit, O. and M. Wolf, “Improved Estimation of the Covariance Matrix of Stock Returns with an Application to Portfolio Selection,” Journal of Empirical Finance, Vol. 10, No. 5 (2003), pp. 603-621).

All the methods discussed so far, although published in recent years, are derived from (very) classical areas of mathematics: Geometry and linear algebra. A correlation matrix is a linear algebra object that measures the cosines of the angles between any two vectors in the vector space formed by the returns series (see Calkin, N. and M. Lopez de Prado, “Stochastic Flow Diagrams,” Algorithmic Finance, Vol. 3, No. 1 (2014), pp. 21-42 (available at http://ssrn.com/abstract=2379314); also see Calkin, N. and M. Lopez de Prado, “The Topology of Macro Financial Flows: An Application of Stochastic Flow Diagrams,” Algorithmic Finance, Vol. 3, No. 1 (2014), pp. 43-85 (available at http://ssrn.com/abstract=2379319). One reason for the instability of quadratic optimizers is that the vector space is modelled as a complete (fully connected) graph, where every node is a potential candidate to substitute another. In algorithmic terms, inverting the matrix means evaluating the rates of substitution across the complete graph.

FIG. 1A depicts a visual representation of the relationships implied by a covariance matrix of 50×50, that is fifty nodes and 1225 edges. Small estimation errors over several edges compound to lead us to incorrect solutions. Intuitively it would be desirable to drop unnecessary edges.

Let's consider for a moment the subtleties inherent to such topological structure. Suppose that an investor wishes to build a diversified portfolio of securities, including hundreds of stocks, bonds, hedge funds, real estate, private placements, etc. Some investments seem closer substitutes of one another, and other investments seem complementary to one another. For example, stocks could be grouped in terms of liquidity, size and industry region, where stocks within a given group compete for allocations. In deciding the allocation to a large publicly-traded U.S. financial stock like J.P. Morgan, we will consider adding or reducing the allocation to another large publicly-traded U.S. bank like Goldman Sachs, rather than a small community bank in Switzerland, or a real estate holding in the Caribbean. And yet, to a correlation matrix, all investments are potential substitutes to each other. In other words, correlation matrices lack the notion of hierarchy. This lack of hierarchical structure allows weights to vary freely in unintended ways, which is a root cause of CLA's instability.

Furthermore, existing computing systems—even systems with advanced processing capabilities—that handle functions such as portfolio performance simulation and optimization do not typically leverage more sophisticated software-based data processing techniques that can only be performed by specialized computers, often operating in high-density computing clusters operating in parallel and executing advanced data processing techniques such as machine learning and artificial intelligence.

### SUMMARY

Therefore, what is needed is a specialized computing system, including a server computing cluster, that is programmed to execute machine learning techniques in parallel using complex software, including algorithms and processes to implement a hierarchical data structure that enables the computing system to traverse a computer-generated model to determine an optimal allocation for a portfolio of assets.

FIG. 1B depicts a visual representation of a hierarchical (tree) structure as generated by the clustered machine learning techniques described herein. It should be appreciated that a tree structure introduces two desirable features: a) It has only N−1 edges to connect N nodes, so the weights only rebalance among peers at various hierarchical levels; and b) the weights are distributed top-down, consistent with how many asset managers build their portfolios, from asset class to sectors to individual securities. For these reasons, hierarchical structures are designed to give not only stable but also intuitive results.

The invention, in one aspect, features a system comprising a cluster of server computing devices communicably coupled to each other and to a database computing device, each server computing device having one or more machine learning processors. The cluster of server computing devices is programmed to receive a matrix of observations. The cluster of server computing devices is programmed to divide the matrix of observations into a plurality of input data sets and transmit each one of the plurality of input data sets to a corresponding machine learning processor. Each machine learning processor is programmed to generate a first data structure for a distance matrix based upon the corresponding input data set. The distance matrix comprises a plurality of items. Each machine learning processor is programmed to determine a distance between any two column-vectors of the distance matrix, and generate a cluster of items using a pair of columns associated with the two column-vectors. Each machine learning processor is programmed to define a distance between the cluster and unclustered items of the distance matrix, and update the distance matrix by appending the cluster and defined distance to the distance matrix and dropping clustered columns and rows of the distance matrix. Each machine learning processor is programmed to append one or more additional clusters to the distance matrix by repeating steps e)-g) for each additional cluster. Each machine learning processor is programmed to generate a second data structure for a linkage matrix using the clustered distance matrix. Each machine learning processor is programmed to analyze the linkage matrix to determine a number of items per cluster, and analyze the linkage matrix to assign a weight to each cluster based upon a distance of the cluster to other clusters and a size of the cluster. Each machine learning processor is programmed to generate a third data structure containing the clusters and assigned weights. The cluster of server computing devices is programmed to consolidate each third data structure from each machine learning processor into a hierarchical data structure and transmit the hierarchical data structure to a remote computing device.

The invention, in another aspect, features a method. The method comprises receiving, a cluster of server computing devices communicably coupled to each other and to a database computing device and each server computing device comprising one or more machine learning processors, a matrix of observations. The cluster of server computing devices divides the matrix of observations into a plurality of input data sets and transmits each one of the plurality of input data sets to a corresponding machine learning processor. Each machine learning processor generates a first data structure for a distance matrix based upon the corresponding input data set. The distance matrix comprises a plurality of items. Each machine learning processor determines a distance between any two column-vectors of the distance matrix, and generates a cluster of items using a pair of columns associated with the two column-vectors. Each machine learning processor defines a distance between the cluster and unclustered items of the distance matrix, and updates the distance matrix by appending the cluster and defined distance to the distance matrix and dropping clustered columns and rows of the distance matrix. Each machine learning processor appends one or more additional clusters to the distance matrix by repeating steps d)-f) for each additional cluster. Each machine learning processor generates a second data structure for a linkage matrix using the clustered distance matrix. Each machine learning processor analyzes the linkage matrix to determine a number of items per cluster, and analyzes the linkage matrix to assign a weight to each cluster based upon a distance of the cluster to other clusters and a size of the cluster. Each machine learning processor generates a third data structure containing the clusters and assigned weights. The cluster of server computing devices consolidates each third data structure from each machine learning processor into hierarchical data structure and transmits the hierarchical data structure to a remote computing device.

The invention, in another aspect, features a computer program product tangibly embodied in a non-transitory computer readable storage device. The computer program product includes instructions that when executed, cause a cluster of server computing devices communicably coupled to each other and to a database computing device, each server computing device comprising one or more machine learning processors, to receive a matrix of observations. The cluster of server computing devices divides the matrix of observations into a plurality of input data sets and transmits each one of the plurality of input data sets to a corresponding machine learning processor. Each machine learning processor generates a first data structure for a distance matrix based upon the corresponding input data set. The distance matrix comprises a plurality of items. Each machine learning processor determines a distance between any two column-vectors of the distance matrix, and generates a cluster of items using a pair of columns associated with the two column-vectors. Each machine learning processor defines a distance between the cluster and unclustered items of the distance matrix, and updates the distance matrix by appending the cluster and defined distance to the distance matrix and dropping clustered columns and rows of the distance matrix. Each machine learning processor appends one or more additional clusters to the distance matrix by repeating steps d)-f) for each additional cluster. Each machine learning processor generates a second data structure for a linkage matrix using the clustered distance matrix. Each machine learning processor analyzes the linkage matrix to determine a number of items per cluster, and analyzes the linkage matrix to assign a weight to each cluster based upon a distance of the cluster to other clusters and a size of the cluster. Each machine learning processor generates a third data structure containing the clusters and assigned weights. The cluster of server computing devices consolidates each third data structure from each machine learning processor into a hierarchical data structure and transmitting the hierarchical data structure to a remote computing device.

Any of the above aspects can include one or more of the following features. In some embodiments, generating a first data structure for a distance matrix further comprises generating a correlation matrix based upon the input data set; defining a distance measure using the correlation matrix; and generating the first data structure based upon the correlation matrix and the distance. In some embodiments, the distance between any two column-vectors of the distance matrix comprises a Euclidian distance. In some embodiments, the distance between the cluster and unclustered items of the distance matrix is determined using a nearest point algorithm.

In some embodiments, analyzing the linkage matrix to determine a number of items per cluster further comprises assigning a unit size to each item; and determining a size of each cluster based upon the unit size assigned to each item in the cluster. In some embodiments, analyzing the linkage matrix to assign a weight to each cluster further comprises assigning an equal weight to clusters that are separated by a distance that falls below a predetermined threshold; and assigning a weight that is proportional to the size of each cluster where the clusters are separated by a distance that falls above a predetermined threshold. In some embodiments, the remote computing device uses the weights in the third data structure to rebalance an asset allocation for a financial portfolio.

In some embodiments, each server computing device includes a plurality of machine learning processors, each machine learning processor having a plurality of processing cores. In some embodiments, each processing core of each machine learning processor receives and processes a portion of the corresponding input data set.

Other aspects and advantages of the invention will become apparent from the following detailed description, taken in conjunction with the accompanying drawings, illustrating the principles of the invention by way of example only.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1A depicts a visual representation of the relationships implied by a covariance matrix of 50×50.

FIG. 1B depicts a visual representation of a hierarchical (tree) structure.

FIG. 2 is a block diagram of a system 200 used in a computing environment for generating optimized portfolio allocation strategies.

FIGS. 3A and 3B comprise a flow diagram of a method of generating optimized portfolio allocation strategies.

FIG. 4 is an example of encoding a correlation matrix p as a distance matrix D.

FIG. 5 is an example of determining of a Euclidian distance of correlation distances.

FIG. 6 is an example of clustering a pair of columns.

FIG. 7 is an example of defining the distance between an item and the newly-formed cluster.

FIG. 8 is an example of updating the matrix with the newly-formed cluster.

FIG. 9 an example of the recursion process to append further clusters to the matrix.

FIG. 10 is a graph depicting the clusters formed at each iteration of the recursion process.

FIG. 11 is an example of computer code to implement the bottom-up pass in the allocation algorithm.

FIG. 12 is an example of computer code to implement the top-down pass.

FIG. 13 depicts an exemplary correlation matrix as a heatmap.

FIG. 14 depicts an exemplary dendogram of the resulting clusters.

FIG. 15 is another representation of the correlation matrix of FIG. 13, reorganized in blocks according to the identified clusters.

FIGS. 16A and 16B depict exemplary computer code for the correlation matrix and clustering processes.

FIG. 17 depicts a table with different allocations resulting from three portfolio strategies: CLA portfolio strategy, HCA portfolio strategy, and inverse-volatility portfolio strategy.

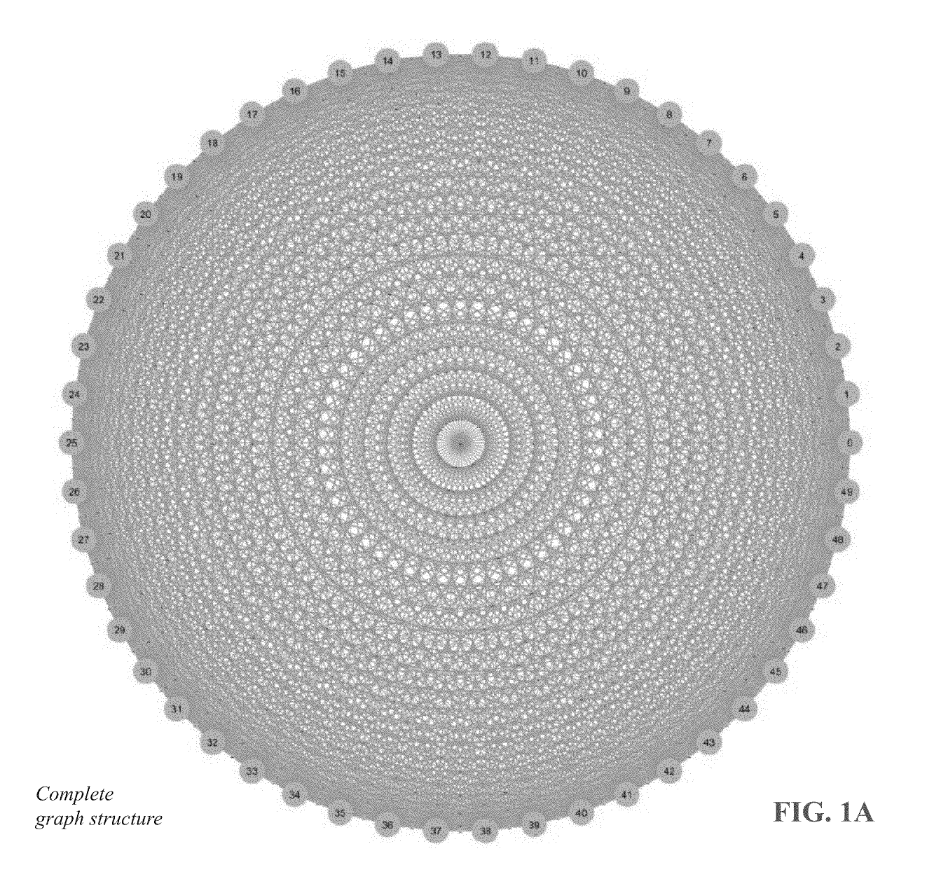

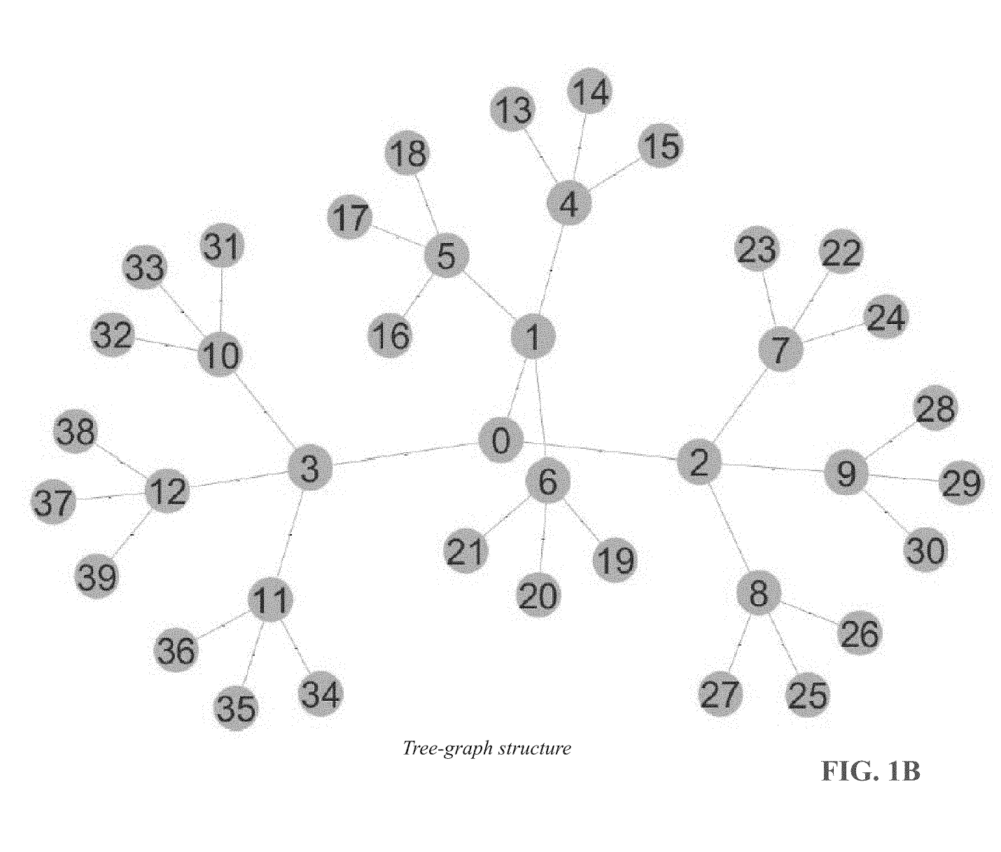

### DETAILED DESCRIPTION

The methods and systems described herein provide a computerized portfolio construction method that addresses CLA's instability issues thanks to the use of modern computer data analysis techniques: graph theory and machine learning using a cluster of computing devices operating in parallel. The Hierarchical Capital Allocation (HCA) methodology set forth herein uses the information contained in the covariance matrix without requiring its inversion or positive-definitiveness. In fact, HCA can compute a portfolio based on a singular covariance matrix, an impossible feat for convex-family optimizers.

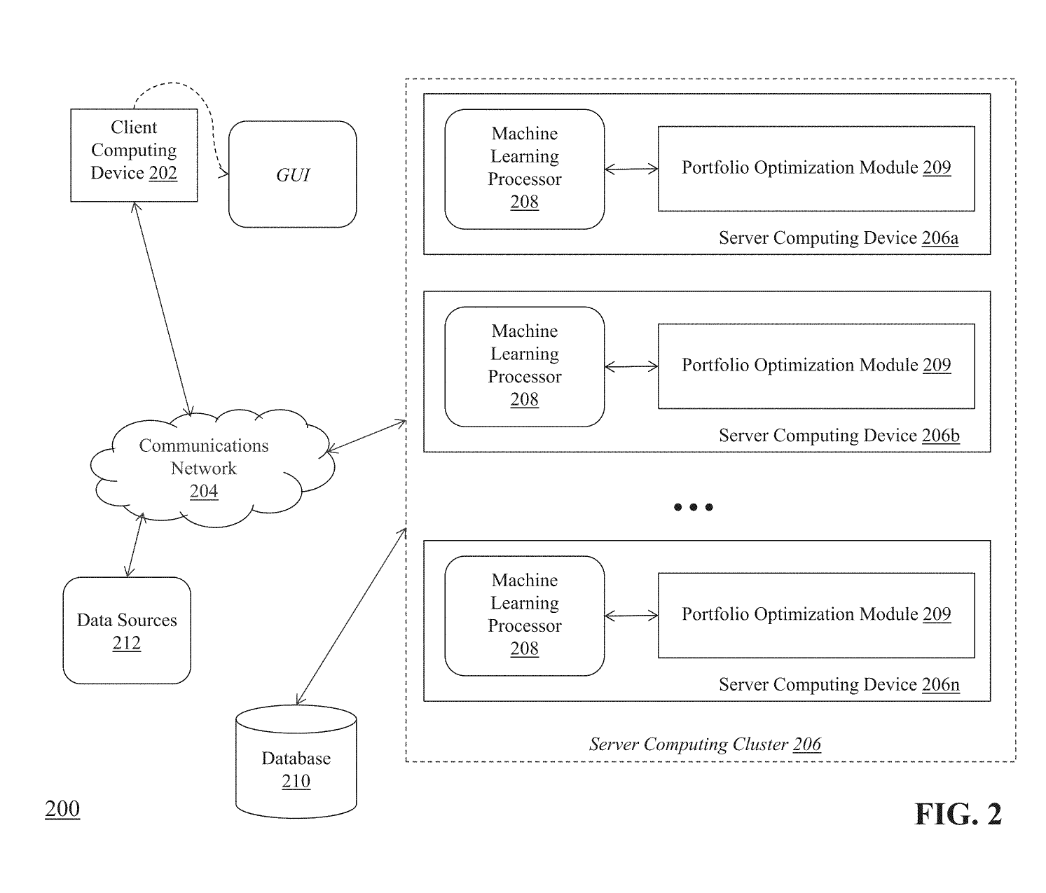

FIG. 2 is a block diagram of a system 200 used in a computing environment for generating optimized portfolio allocation strategies using a machine learning processor (e.g., processor 208). The system 200 includes a client computing device 202, a communications network 204, a plurality of server computing devices 206a-206n arranged in a server computing cluster 206, each server computing device 206a-206n having one or more specialized machine learning processors 208 that each executes a portfolio optimization module 209. The system 200 also includes a database 210 and one or more data sources 212.

The client computing device 202 connects to the communications network 204 in order to communicate with the server computing cluster 206 to provide input and receive output relating to the process of generating optimized portfolio allocation strategies using a machine learning processor as described herein. For example, client computing device 202 can be coupled to a display device that presents a detailed graphical user interface (GUI) with output resulting from the methods and processes described herein, where the GUI is utilized by an operator to review the output generated by the system. In addition, the client computing device 202 can be coupled to one or more input devices that enable an operator of the client device to provide input to the other components of the system for the purposes described herein.

Exemplary client devices 202 include but are not limited to desktop computers, laptop computers, tablets, mobile devices, smartphones, and internet appliances. It should be appreciated that other types of computing devices that are capable of connecting to the components of the system 200 can be used without departing from the scope of invention. Although FIG. 2 depicts a single client device 202, it should be appreciated that the system 200 can include any number of client devices. And as mentioned above, in some embodiments the client device 202 also includes a display for receiving data from the server computing device 206 and displaying the data to a user of the client device 202.

The communication network 204 enables the other components of the system 200 to communicate with each other in order to perform the process of generating optimized portfolio allocation strategies using a machine learning processor as described herein. The network 204 may be a local network, such as a LAN, or a wide area network, such as the Internet and/or a cellular network. In some embodiments, the network 104 is comprised of several discrete networks and/or sub-networks (e.g., cellular to Internet) that enable the components of the system 200 to communicate with each other.

Each server computing device 206a-206n in the cluster 206 is a combination of hardware, which includes one or more specialized machine learning processors 208 and one or more physical memory modules, and specialized software modules—including the portfolio optimization module 209—that execute on the machine learning processors 208 of the associated server computing device 206a-206n, to receive data from other components of the system 200, transmit data to other components of the system 200, and perform functions for generating optimized portfolio allocation strategies using a machine learning processor as described herein.

The machine learning processors 208 and the corresponding software module 209 are key components of the technology described herein, in that these components 208, 209 provide the beneficial technical improvement of enabling the system 200 to automatically process and analyze large sets of complex computer data elements using a plurality of computer-generated machine learning models to generate user-specific actionable output relating to the selection and optimization of financial portfolio asset allocation. The machine learning processors 208 executes artificial intelligence algorithms as contained within the module 209 to constantly improve the machine learning model by automatically assimilating newly-collected data elements into the model without relying on any manual intervention. In addition, the machine learning processors 208 operate in parallel on a divided input data set, which enables the rapid execution of a number of portfolio allocation algorithms and generation of a large portfolio allocation hierarchical data structure in conjunction with specifically-constructed attributes, a function that both necessitates the use of a specially-programmed microprocessor cluster and that would not be feasible to accomplish using general-purpose processors and/or manual techniques.

Each machine learning processor 208 is a microprocessor embedded in the corresponding server computing device 206 that is configured to retrieve data elements from the database 210 and the data sources 212 for the execution of the portfolio optimization module 209. Each machine learning processor 208 is programmed with instructions to execute artificial intelligence algorithms that automatically process the input and traverse computer-generated models in order to generate specialized output corresponding to the module. Each machine learning processor 208 can transmit the specialized output to downstream computing devices for analysis and execution of additional computerized actions.

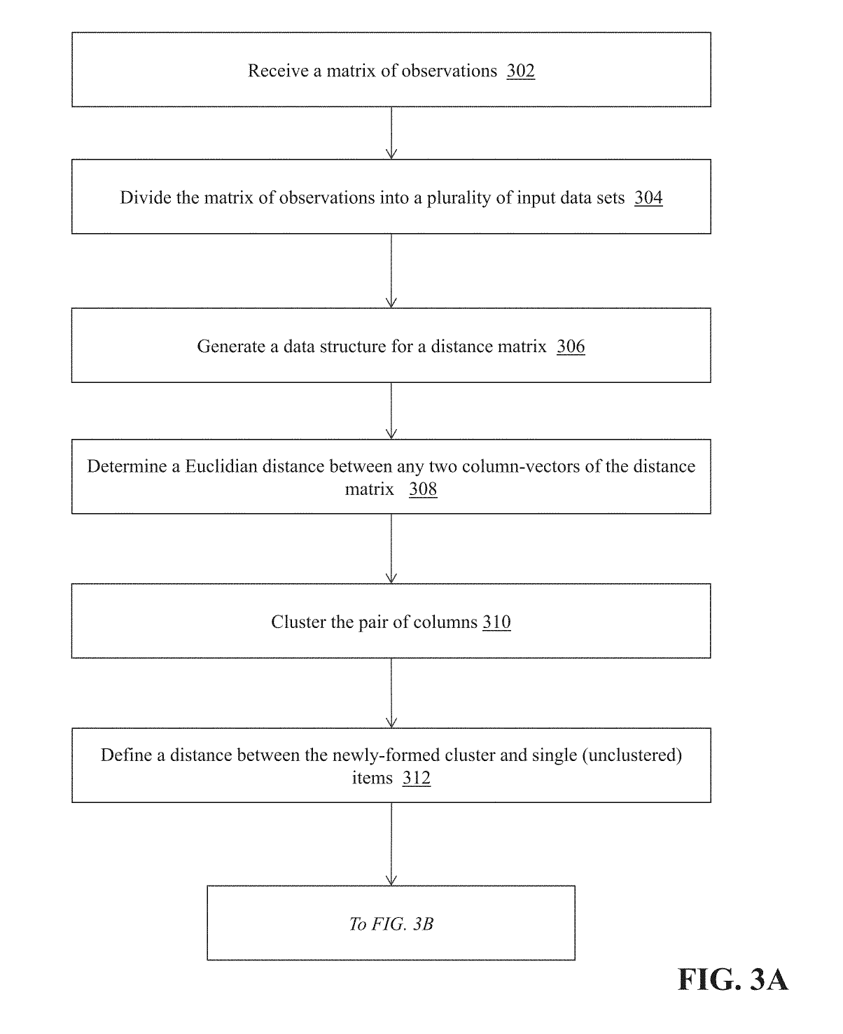

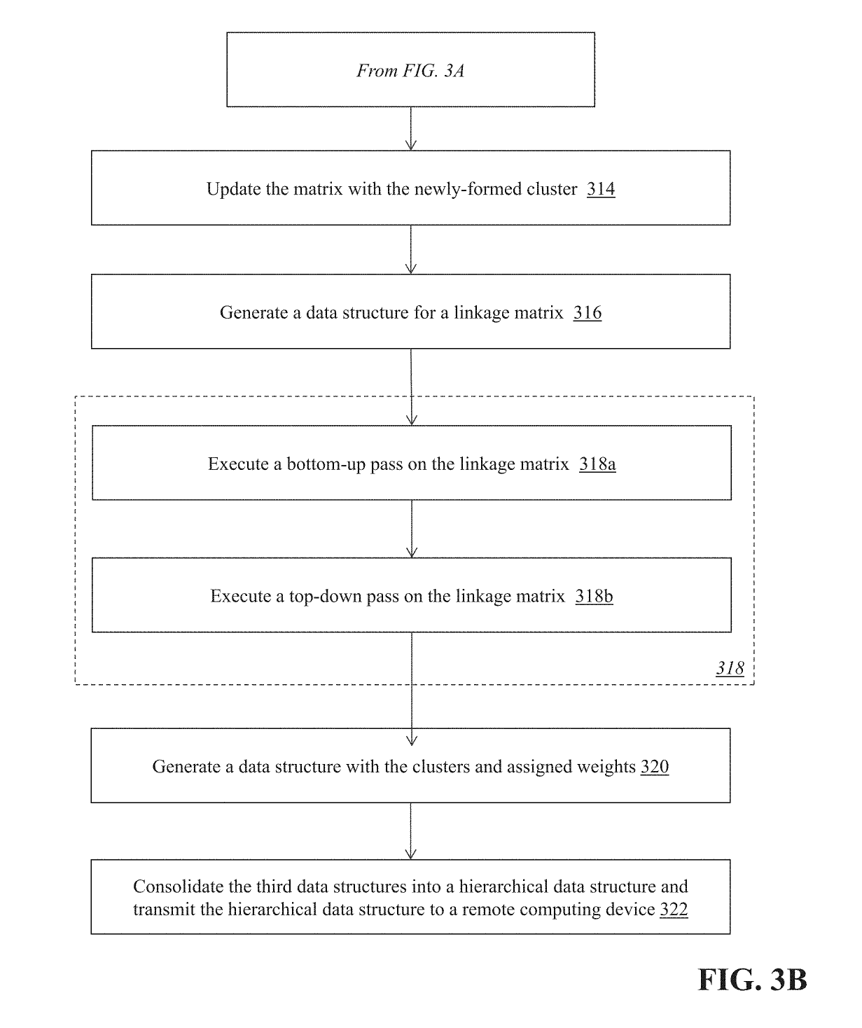

Each machine learning processor 208 executes a variety of algorithms and generates different data structures (including, in some embodiments, computer-generated models) to achieve the objectives described herein. An exemplary workflow is described further below in this description with respect to FIGS. 3A and 3B. In one example, in some embodiments, in both the model training and model operation phases, the first step performed by each machine learning processor 208 is a data preparation step that cleans the structured and unstructured data collected. Data preparation involves eliminating incomplete data elements or filling in missing values, constructing calculated variables as functions of data provided, formatting information collected to ensure consistency, data normalization or data scaling and other pre-processing tasks.

In the training phase, initial data processing may lead to a reduction of the complexity of the data set through a process of variable selection. The process is meant to identify non-redundant characteristics present in the data collected that will be used in the computer-generated analytical model. This process also helps determine which variables are meaningful in analysis and which can be ignored. It should be appreciated that by “pruning” the dataset in this manner, the system achieves significant computational efficiencies in reducing the amount of data needed to be processed and thereby effecting a corresponding reduction in computing cycles required.

In addition, in some embodiments the machine learning model includes a class of models that can be summarized as supervised learning or classification, where a training set of data is used to build a predictive model that will be used on “out of sample” or unseen data to predict the desired outcome. In one embodiment, the linear regression technique is used to predict the appropriate categorization of an asset and/or an allocation of assets based on input variables. In another embodiment, a decision tree model can be used to predict the appropriate classification of an asset and/or an allocation of assets. Clustering or cluster analysis is another technique that may be employed, which classifies data into groups based on similarity with other members of the group.

Each machine learning processor 208 can also employ non-parametric models. These models do not assume that there is a fixed and unchanging relationship between the inputs and outputs, but rather the computer-generated model automatically evolves as the data grows and more experience and feedback is applied. Certain pattern recognition models, such as the k-Nearest Neighbors algorithm, are examples of such models.

Furthermore, each machine learning processor 208 develops, tests and validates the computer-generated model described herein iteratively according to the step highlighted above. For example, each processor 208 scores each model objective function and continuously selects the model with the best outcomes.

In some embodiments, the portfolio optimization module 209 is a specialized set of artificial intelligence-based software instructions programmed onto the associated machine learning processor 208 in the server computing device 206 and can include specifically-designated memory locations and/or registers for executing the specialized computer software instructions. Further explanation of the specific processing performed by the module 209 is provided below.

The database 210 is a computing device (or in some embodiments, a set of computing devices) that is coupled to the server computing cluster 206 and is configured to receive, generate, and store specific segments of data relating to the process of generating optimized portfolio allocation strategies using a machine learning processor as described herein. In some embodiments, all or a portion of the database 210 can be integrated with the server computing device 206 or be located on a separate computing device or devices. For example, the database 210 can comprise one or more databases, such as MySQL™ available from Oracle Corp. of Redwood City, Calif.

The data sources 212 comprise a variety of databases, data feeds, and other sources that supply data to each machine learning processor 208 to be used in generating optimized portfolio allocation strategies using a machine learning processor as described herein. The data sources 212 can provide data to the server computing device according to any of a number of different schedules (e.g., real-time, daily, weekly, monthly, etc.) The specific data elements provided to the processors 208 by the data sources 212 are described in greater detail below.

Further to the above elements of system 200, it should be appreciated that the machine learning processors 208 can build and train the computer-generated model prior to conducting the processing described herein. For example, each machine learning processor 208 can retrieve relevant data elements from the database 210 and/or the data sources 212 to execute algorithms necessary to build and train the computer-generated model (e.g., input data, target attributes) and execute the corresponding artificial intelligence algorithms against the input data set to find patterns in the input data that map to the target attributes. Once the applicable computer-generated model is built and trained, the machine learning processors 208 can automatically feed new input data (e.g., an input data set) for which the target attributes are unknown into the model using, e.g., the price optimization module 209. Each machine learning processor 208 then executes the corresponding module 209 to generate predictions about how the data set maps to target attributes. Each machine learning processor 208 then creates an output set based upon the predicted target attributes. It should be appreciated that the computer-generated models described herein are specialized data structures that are traversed by the machine learning processors 208 to perform the specific functions for generating optimized portfolio allocation strategies as described herein. For example, in one embodiment, the models are a framework of assumptions expressed in a probabilistic graphical format (e.g., a vector space, a matrix, and the like) with parameters and variables of the model expressed as random components.

FIGS. 3A and 3B comprise a flow diagram of a method of generating optimized portfolio allocation strategies, using the system 200 of FIG. 2. The server computing cluster 206 receives (302) a T×N matrix of observations. For example, the server computing cluster 206 collects data from a variety of data feeds and sources (e.g., database 210, data sources 212) and consolidates the collected data into time series data (e.g., one time series per financial instrument or security) aligned in columns (e.g., one column per security) by a timestamp associated with the data. In one embodiment, the data is sampled in terms of equal volume buckets at the same speed as the market. Using a parallelization layer, the server computing cluster 206 divides (304) the matrix of observations into a plurality of input data sets (or tasks) and transmits each input data set to, e.g., a different machine learning processor 208 of the cluster 206. In some embodiments, each machine learning processor 208 is comprised of a plurality of processing cores (e.g., 24 cores) and the server computing cluster 206 transmits a separate input data set (or task) to each core of each machine learning processor. For example, if the server computing cluster 206 comprises 100 server computing devices and each processor has 24 cores, the cluster 206 is capable of dividing the matrix of observations into 24,000 separate input data sets and transmitting each input data set to a different core, thereby enabling the cluster 206 to process the input data sets in parallel—which realizes a significant increase of processing speed and efficiency over traditional computing systems.

Each machine learning processor 208 executes the corresponding portfolio optimization module 209 to combine the N items of the matrix into a hierarchical structure of clusters, so that allocations can be “trickled down” through a tree graph.

First, each machine learning processor 208 executes the corresponding portfolio optimization module 209 to generate a data structure for a N×N correlation matrix with entries

ρ={ρ_{i,j}}_{i,j=1, . . . ,N}, where ρ_{i,j}=ρ[Xᵢ,Xⱼ].

The distance measure is defined as

d:(Xᵢ,Xⱼ)⊂B→ [symbol] ε[0,1], d_{i,j}=d[Xᵢ,Xⱼ]=\sqrt{1/2(1−ρ_{i,j})},

where B is the Cartesian product of items in {1, . . . , i, . . . , N}. This allows each machine learning processor 208 to generate (306) a data structure for a N×N distance matrix D={d_{i,j}}_{i,j=1, . . . , N}. Matrix D is a proper metric, in the sense that d[X,Y]≧0 (non-negativity), d[X,Y]=0 [symbol] X=Y (coincidence), d[X,Y]=d[Y,X] (symmetry), and d[X,Z]≦d[X,Y]+d[Y,Z] (sub-additivity).

The metric S [X, Y] could be defined as the Pearson correlation between any two vectors X and Y, that is S[X, Y]=p[X,Y], −1<S[X,Y]≦1. The following is a proof that \tilde{d}[X,Y]=\sqrt{1−|ρ[X,Y]|} is a true metric.

First, consider the Euclidian distance of two vectors d[X,Y]=\sqrt{Σₜ₌₁^{T}(Xₜ−Yₜ)}². Second, the vectors are z-standardized and rotated as

$$x = \frac{X - \overline{X}}{σ [ X ]} , y = \frac{Y - \overline{Y}}{σ [ Y ]} sgn [ ρ [ X , Y ] ] .$$

Consequently, 0≦ρ[X,Y]=|ρ[X,Y]|. Third, the Euclidian distance d[x,y] is computed:

$$\begin{matrix}d [ x , y ] = \sqrt{{\sum }_{t = 1}^{T} {( {x}_{t} - {y}_{t} )}^{2}} \\ = \sqrt{{\sum }_{t = 1}^{T} {x}_{t}^{2} + {\sum }_{t = 1}^{T} {y}_{t}^{2} - 2 {\sum }_{t = 1}^{T} {x}_{t} {y}_{t}} \\ = \sqrt{T + T - 2 T σ [ x , y ]} \\ = \sqrt{2 T ( 1 - ρ {\underbrace{[ x , y} ]}_{= \vert ρ [ X , Y ] \vert} )} = \sqrt{2 T} \tilde{d} [ X , Y ]\end{matrix}$$

In other words,

$$\tilde{d} [ X , Y ] = \frac{1}{\sqrt{2 T}} d [ x , y ] ,$$

a linear multiple of the Euclidian distance between the vectors after z-standardization and orthogonal rotation. Given two vertices u and v, W⁽ⁱ⁾[u, v] is denoted as the shortest walk that connects them, and D⁽ⁱ⁾[u,v]=Σ_{eεw}_{⁽ⁱ⁾}_{[u,v]}\sqrt{1−|ω⁽ⁱ⁾[e]|} is computed as the distance between them.

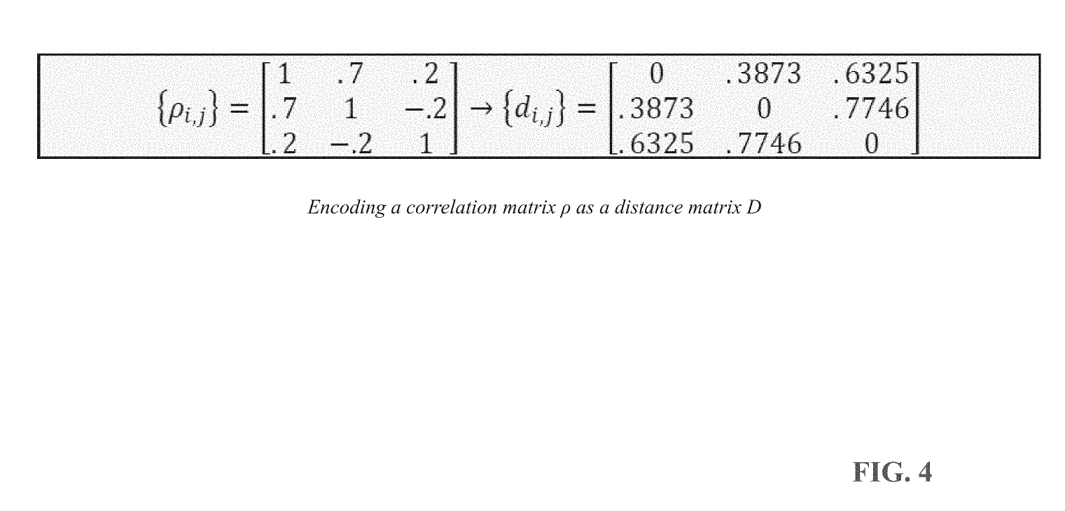

FIG. 4 is an example of encoding a correlation matrix ρ as a distance matrix D as executed by each machine learning processor 208 and the corresponding portfolio optimization module 209.

Next, each machine learning processor 208 executes the portfolio optimization module 209 to determine (308) the Euclidian distance between any two column-vectors of D,

\tilde{d}:(Dᵢ,Dⱼ)⊂B→ [symbol] [0,\sqrt{N}],

\tilde{d}_{i,j}=\tilde{d}[Dᵢ,Dᵢ]=\sqrt{Σₙ₌₁^{N}(d_{n,i}−d_{n,j})²}.

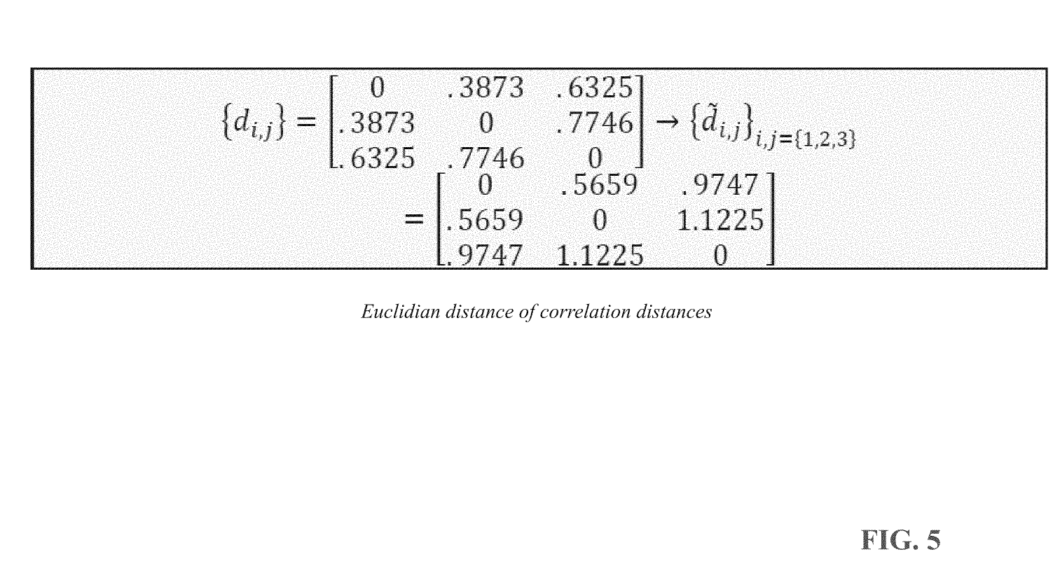

Note the difference between distance metrics d_{i,j} and \tilde{d}_{i,j}. Whereas d_{i,j} is defined on column-vectors of X, \tilde{d}_{i,j} is defined on column-vectors of D (a distance of distances). Therefore, d is a distance defined over the entire metric space D, as each \tilde{d}_{i,j} is a function of the whole correlation matrix (rather than a particular cross-correlation pair). FIG. 5 is an example of determining a Euclidian distance of correlation distances as executed by the machine learning processor 208 and the portfolio optimization module 209.

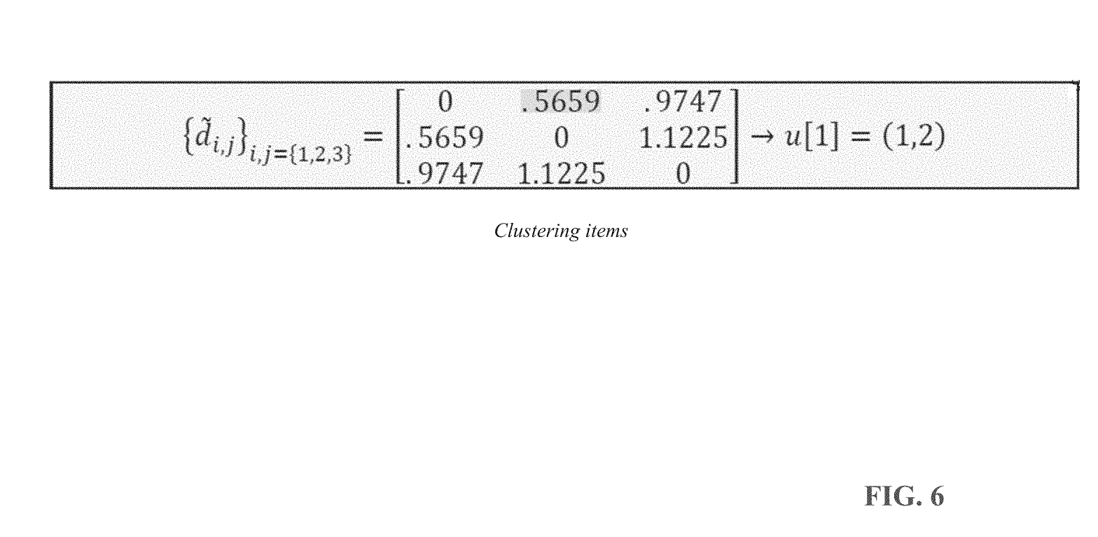

Each machine learning processor 208 then executes the corresponding portfolio optimization module 209 to cluster (310) together the pair of columns (i*,j*) such that (i*,j*)=argmin_{(i,j)}_{_{i≠j}}{\tilde{d}_{i,j}}. The cluster is denoted as u[1]. FIG. 6 is an example of clustering a pair of columns as executed by each machine learning processor 208 and the corresponding portfolio optimization module 209.

Next, the machine learning processor 208 executes the corresponding portfolio optimization module 209 to define (312) the distance between the newly-formed cluster u[1] and single (unclustered) items, so that {\tilde{d}_{i,j}} may be updated. In hierarchical clustering analysis, this is known as the “linkage criterion.” For example, the machine learning processor 208 can define the distance between an item i of \acute{d} and the new cluster u[1] as

\dot{d}_{i,u[1]}=min[{\tilde{d}_{i,j}}_{jεu[1]}] (the nearest point algorithm).

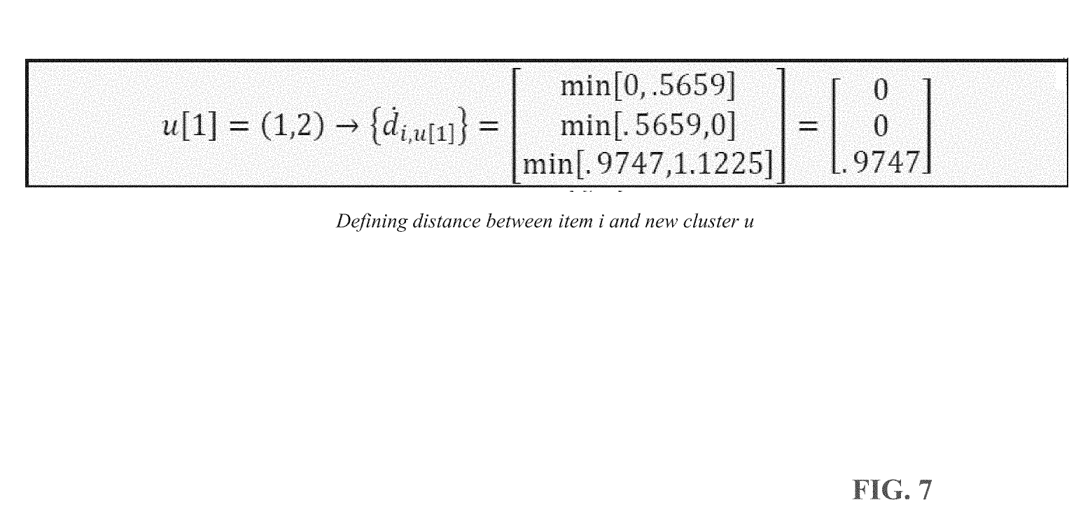

FIG. 7 is an example of defining the distance between an item and the new cluster as executed by the machine learning processor 208 and the corresponding portfolio optimization module 209.

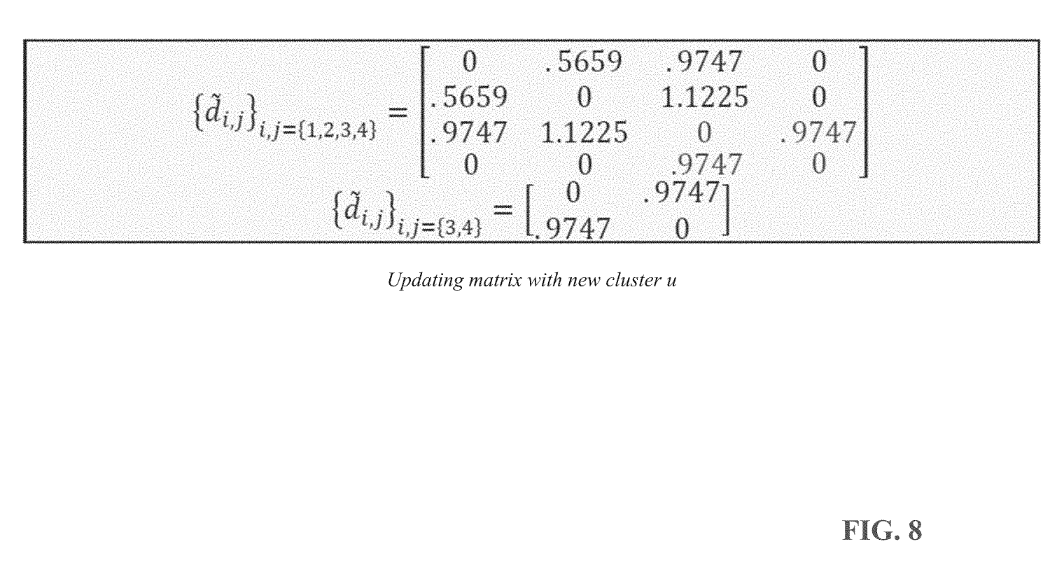

Turning to FIG. 3B, each machine learning processor 208 executes the corresponding portfolio optimization module 209 to update (314) the matrix {\tilde{d}_{i,j}} by appending \dot{d}_{i,u[1]} and dropping the clustered columns and rows jεu[1]. FIG. 8 is an example of updating the matrix {\tilde{d}_{i,j}} in this way.

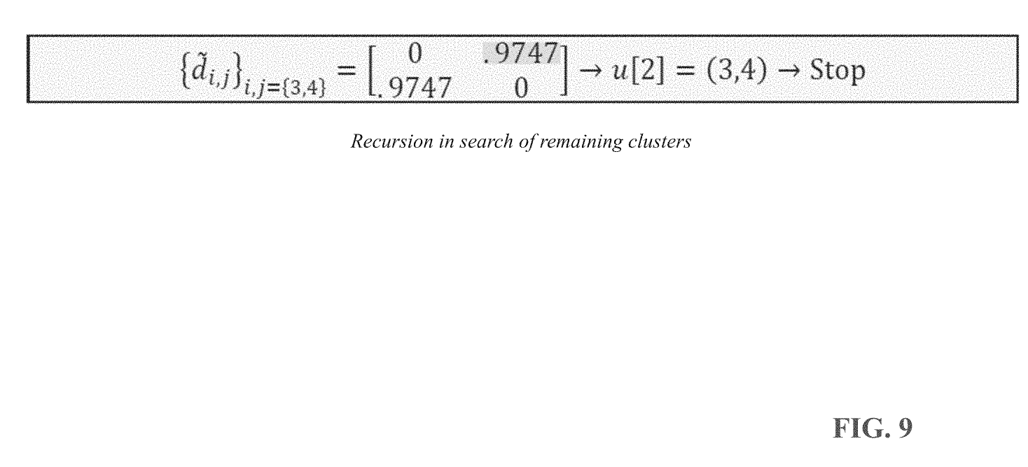

Next, each machine learning processor 208 executes the corresponding portfolio optimization module 209 to recursively apply steps 310, 312, and 314 in order to append N−1 such clusters to matrix D, at which point the final cluster contains all of the original items and the machine learning processor 208 stops the recursion process. FIG. 9 is an example of the recursion process as executed by the machine learning processor 208 and the corresponding portfolio optimization module 209.

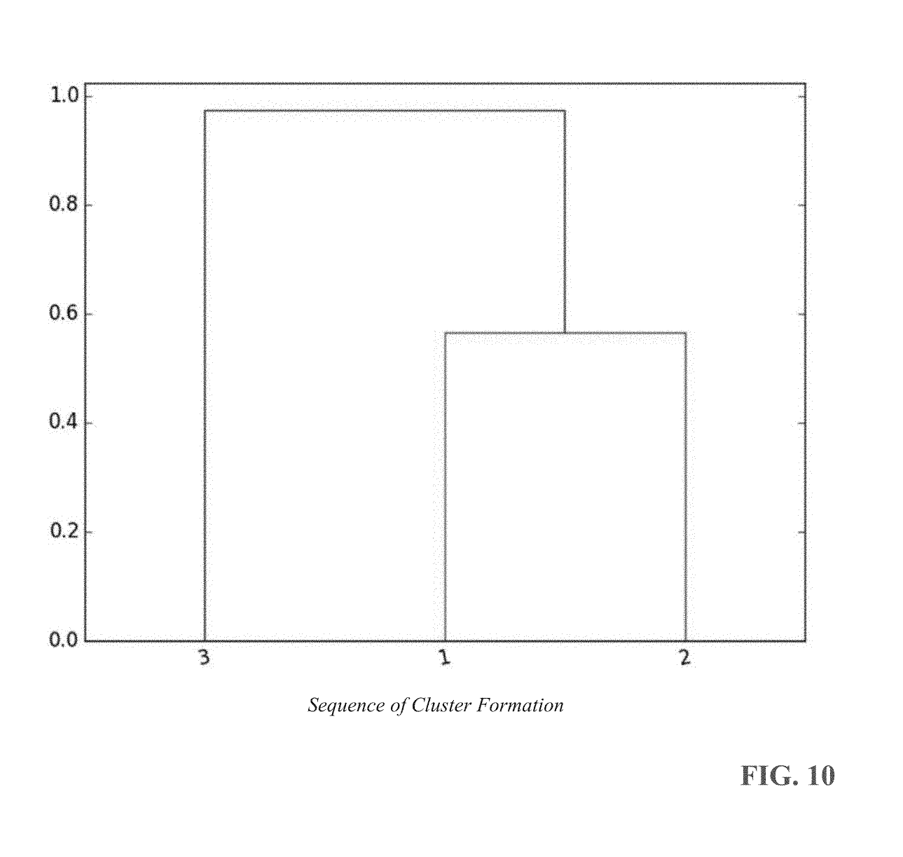

FIG. 10 is a graph depicting the clusters formed at each iteration of the recursive process, as well as the distances d_{i*,j*} that triggered every cluster (i.e., step 308 of FIG. 3). This procedure can be applied to a wide array of distance metrics d_{i,j}, \tilde{d}_{i,j} and \dot{d}_{i,u}, beyond those described in this application. As an example, see Rokach, L. and O. Maimon, “Clustering methods,” in Data mining and knowledge discovery handbook, Springer, U.S. (2005), pp. 321-352 for alternative metrics (which is incorporated herein by reference), as well as algorithms in the scipy library, which are available at http://docs.scipy.org/doc/scipy/reference/generated/scipy.spatial.distance.pdist.html and http://docs.scipy.org/doc/scipy-0.16.0/reference/generated/scipy.cluster.hierarchy.linkage.html.

### From Clusters to Weights

Each machine learning processor 208 then generates (316) a data structure for a linkage matrix as a N×4 matrix with structure

Y={(y_{n,1},y_{n,2},y_{n,3},y_{n,4})}_{n=1, . . . ,N-1}

i.e. with one 4-tuple per cluster. Items (y_{n,1}, y_{n,2}) report the cluster constituents. Item y_{n,3} reports the distance between y_{n,1} and y_{n,2}, that is y_{n,3}=d_{y}_{_{n,1}}_{y}_{_{n,2}}. Item y_{n,3}≦N reports the number of original items included in cluster n. The machine learning processor 208 executes the corresponding portfolio optimization module 209 to initiate an allocation algorithm, which executes (318) two passes on the linkage matrix data structure, and solves the allocation problem in deterministic linear time, T(n)=O(n). The two passes are described below.

### Stage 1: Bottom-Up Pass

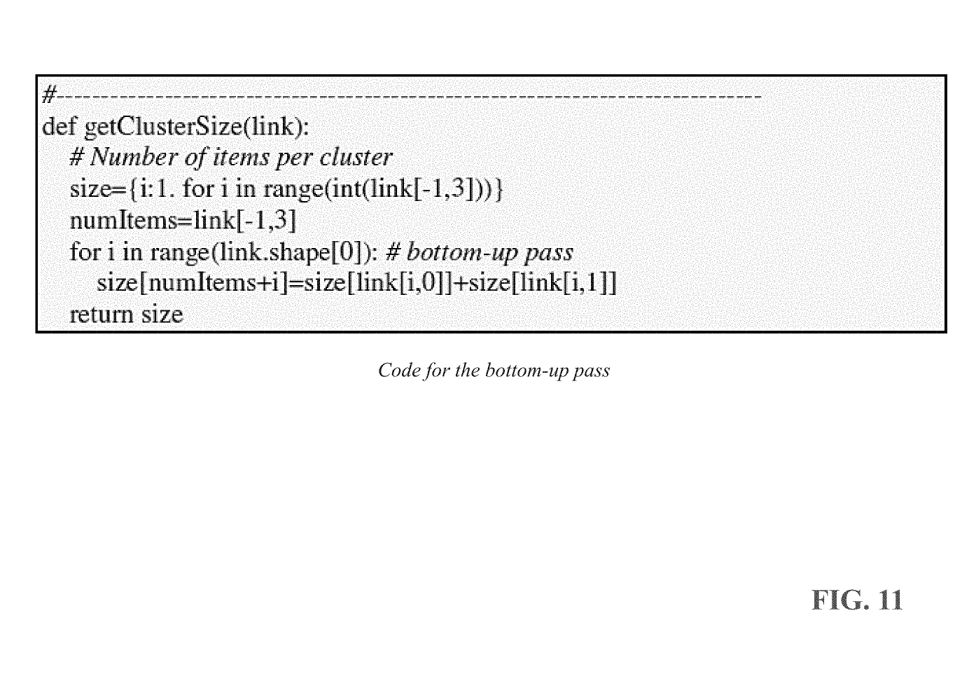

The machine learning processor 208 executes (318a) a bottom-up pass on the linkage matrix which determines the number of items per cluster. Each original item is given a unit size, mᵢ=1, ∀i=1, . . . , N. The size of a cluster is the sum of the sizes of its constituents. For cluster items, n=N+1, . . . , 2N−1, we set mₙ=m_{y}_{_{n,1}}+m_{y}_{_{n,2}}=y_{n-N, 4}, where cluster size is a monotonic increasing function of the number of iterations. FIG. 11 is an example of computer code to implement the bottom-up pass in the allocation algorithm executed by each machine learning processor 208.

### Stage 2: Top-Down Pass

It should be appreciated that, intuitively, allocations should be split equally between any two items (i,j) lying at a short distance \tilde{d}_{i, j}, since those items are deemed similar according to the chosen metric space D. Conversely, when two items are lying far apart, it should be appreciated that allocations should be made proportionally to their relative size, in order to enforce diversification.

To formalize this intuition, each machine learning processor 208 executes (318b) a top-down pass of the allocation algorithm on the linkage matrix.

1. The processor 208 initializes the top-down pass by assigning

a. The full allocation to the last cluster, w_{2N-1}=1

b. n=N−1

2. The processor 208 computes the relative distance:

$$α = \frac{{y}_{n , 3}}{\sqrt{N}} ,$$

so that 0≦a≦1

3. The processor 208 sets the allocation for y_{n,1}:

$${w}_{{y}_{n , 1}} = {w}_{N + n} ( α \frac{1}{2} + ( 1 - α ) \frac{{m}_{{y}_{n , 1}}}{{m}_{{y}_{n , 1}} + {m}_{{y}_{n , 2}}} ) ,$$

where {m_{y}_{_{n,1}}+m_{y}_{_{n,2}}} are the sizes of the constituents, as determined by the bottom-up pass

4. The processor 208 sets the allocation for

$${y}_{n , 2} \text{:} {w}_{{y}_{n , 2}} = {w}_{N + n} ( α \frac{1}{2} + ( 1 - α ) \frac{{m}_{{y}_{n , 2}}}{{m}_{{y}_{n , 1}} + {m}_{{y}_{n , 2}}} )$$

5. The processor 208 sets n=n−1

6. If n=N then the top-down pass ends, else the processor 208 loops back to step 2 above.

It should be appreciated that variable a is defined so that 0≦a≦1. This assumes that 0≦d[y_{n,1}, y_{n,2}]≦1, Euclidian \tilde{d}_{i,j} and Nearest Point \dot{d}_{i,u}, hence 0≦y_{n,3}≦\sqrt{N}. Different distance metrics may require adjusting a's denominator (step 2). Alternatively, we could simply define

$$α = \frac{y}{{max}_{i} \{ {y}_{i , 3} \}} .$$

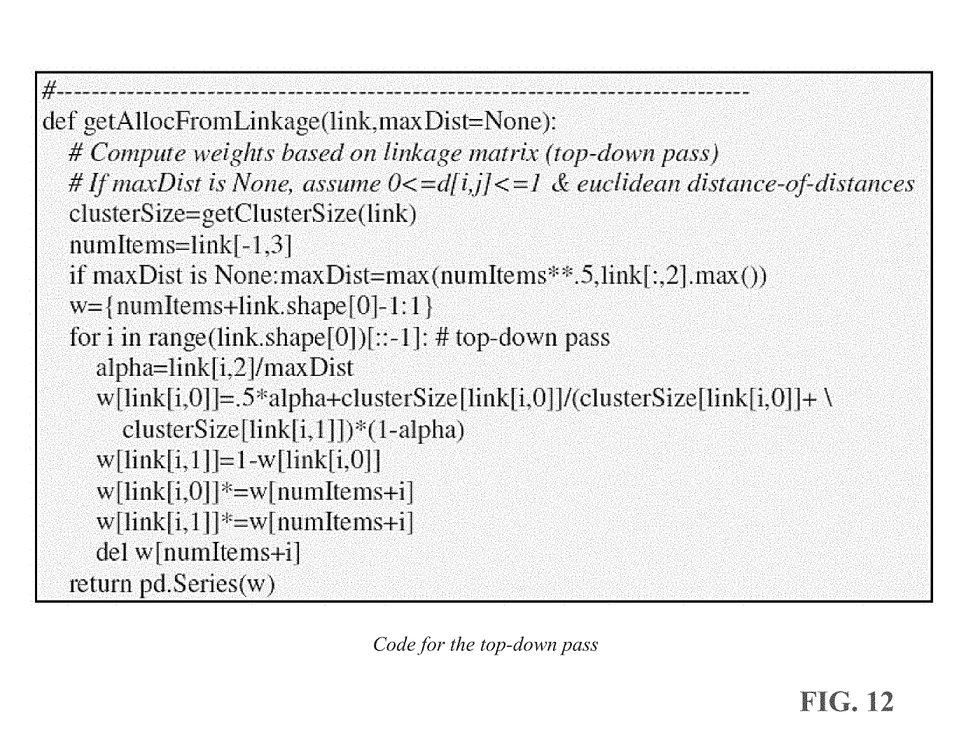

The top-down pass of the allocation algorithm guarantees that 0≦wᵢ≦1, ∀i=1, . . . , N, and Σᵢ₌₁^{N}wᵢ=1, because at each step the processor 208 splits the weights received from higher hierarchical levels. Constraints can be easily introduced in this top-down pass, by replacing the equations in steps 3 and 4 above according to certain preferences. FIG. 12 is an example of computer code to implement the top-down pass in the allocation algorithm executed by each machine learning processor 208.

Once the two passes are complete, each machine learning processor 208 generates (320) a data structure containing the clusters and the assigned weights. The server computing cluster 206 then consolidates (322) the data structures containing the clusters and the assigned weights from each machine learning processor into a hierarchical data structure representing the complete analysis described above, and transmits the hierarchical data structure to a remote computing device (e.g., for rebalancing of asset allocation in a financial portfolio).

### A Numerical Example

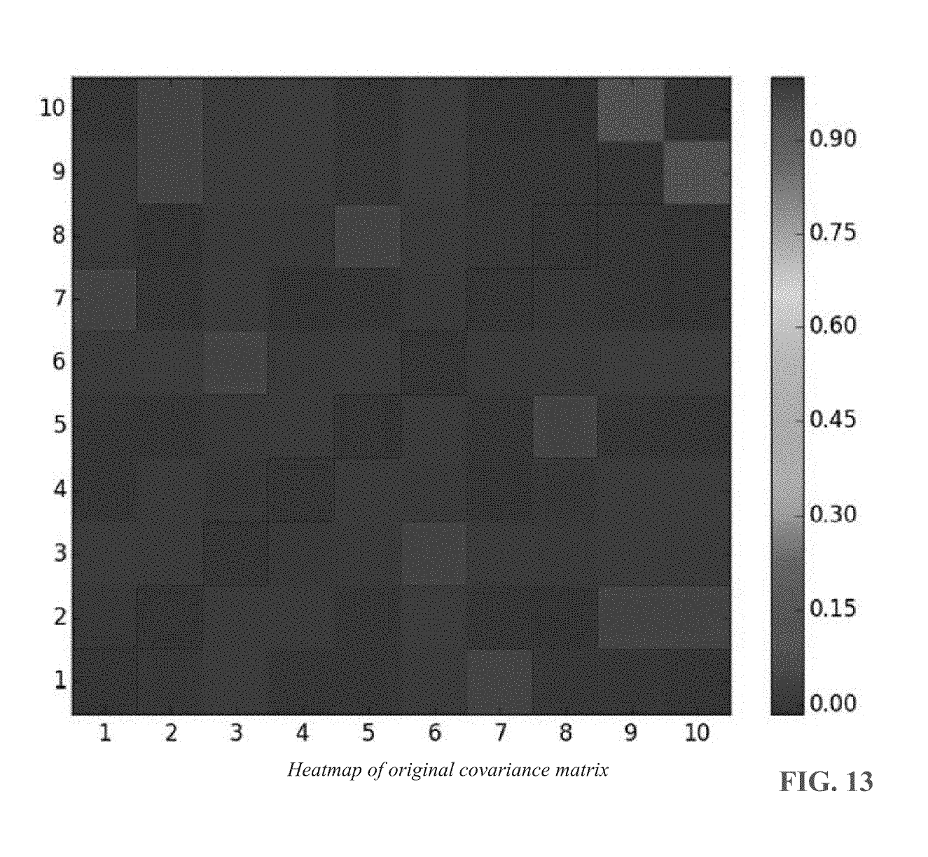

The following is an exemplary numerical use case for executing the process described above with respect to FIGS. 3A and 3B to generate optimized portfolio allocation strategies using the system 200 of FIG. 2. As described previously, each machine learning processor 208 simulates a matrix of observations X, with an exemplary original correlation matrix depicted in FIG. 13 as a heatmap. As shown in FIG. 13, the red squares denote positive correlations and the blue squares denote negative correlations.

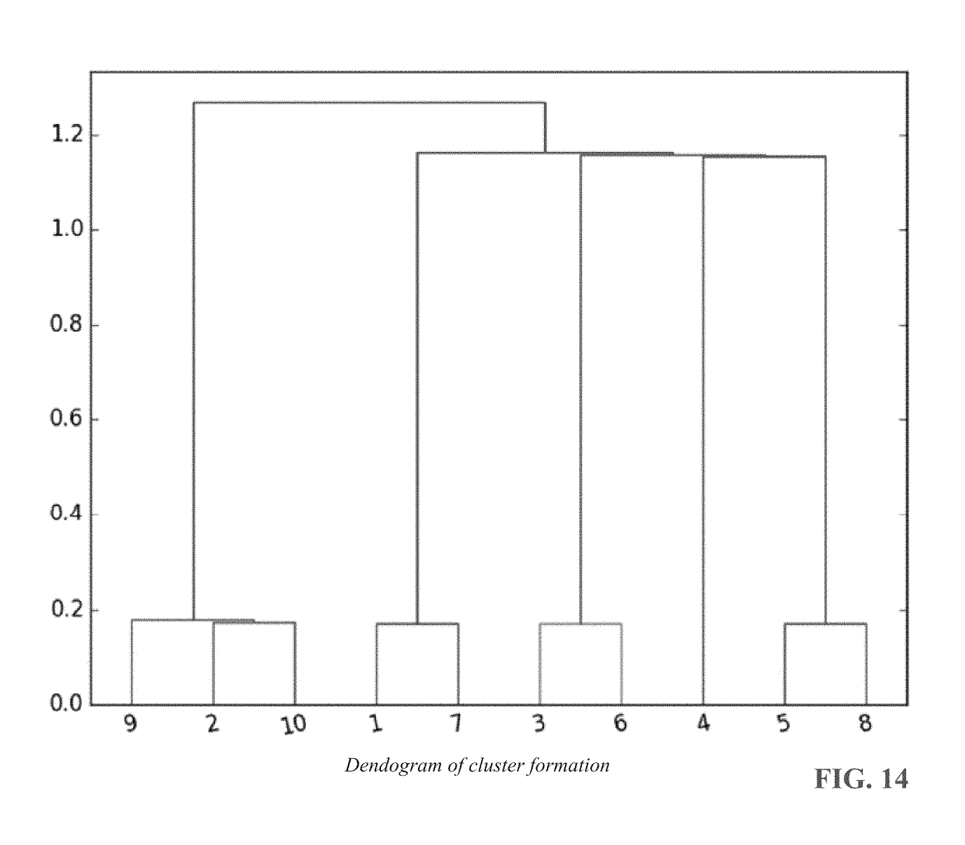

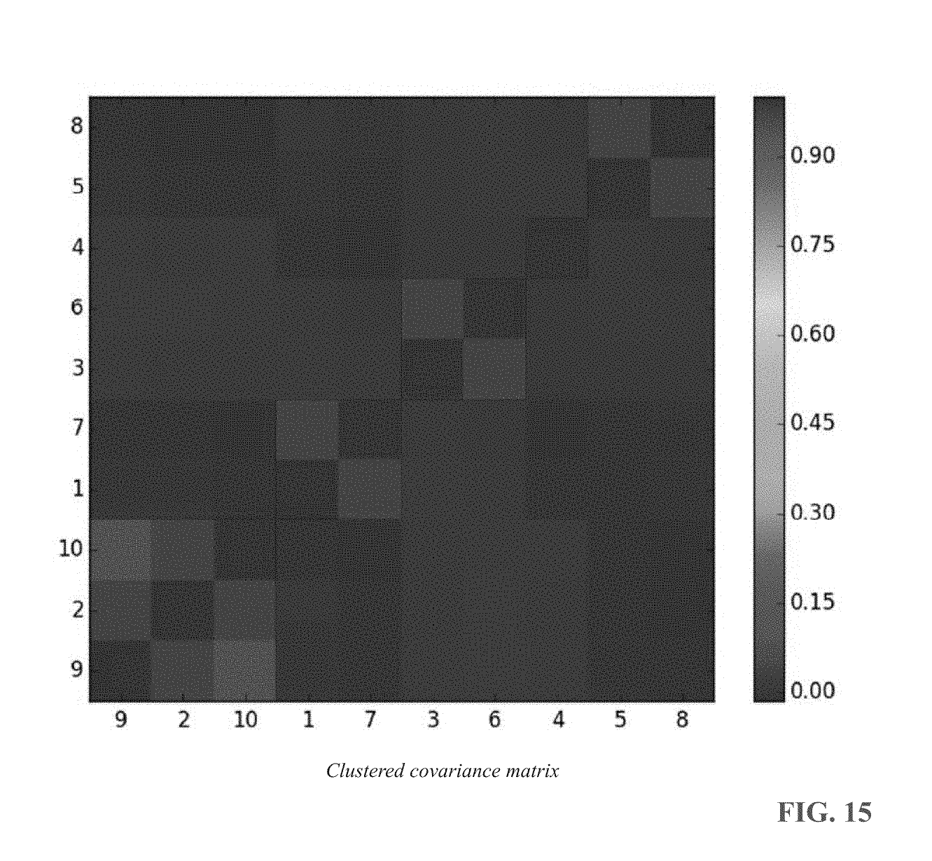

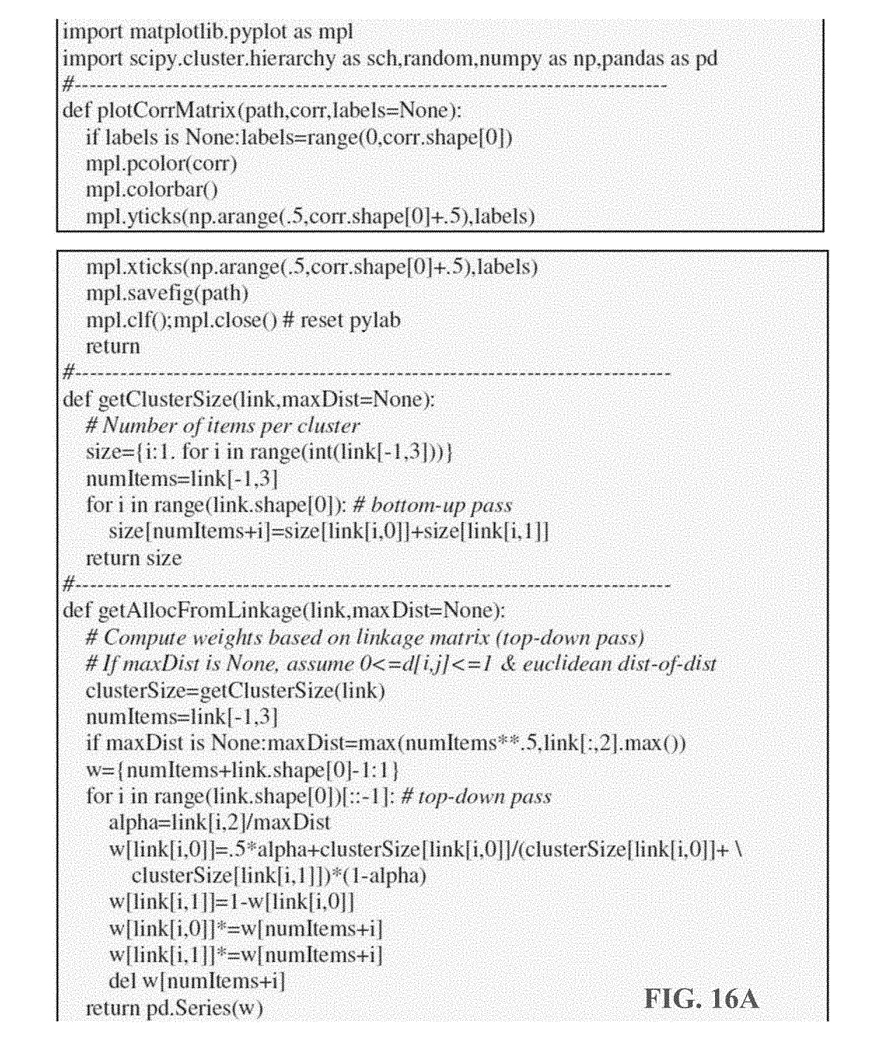

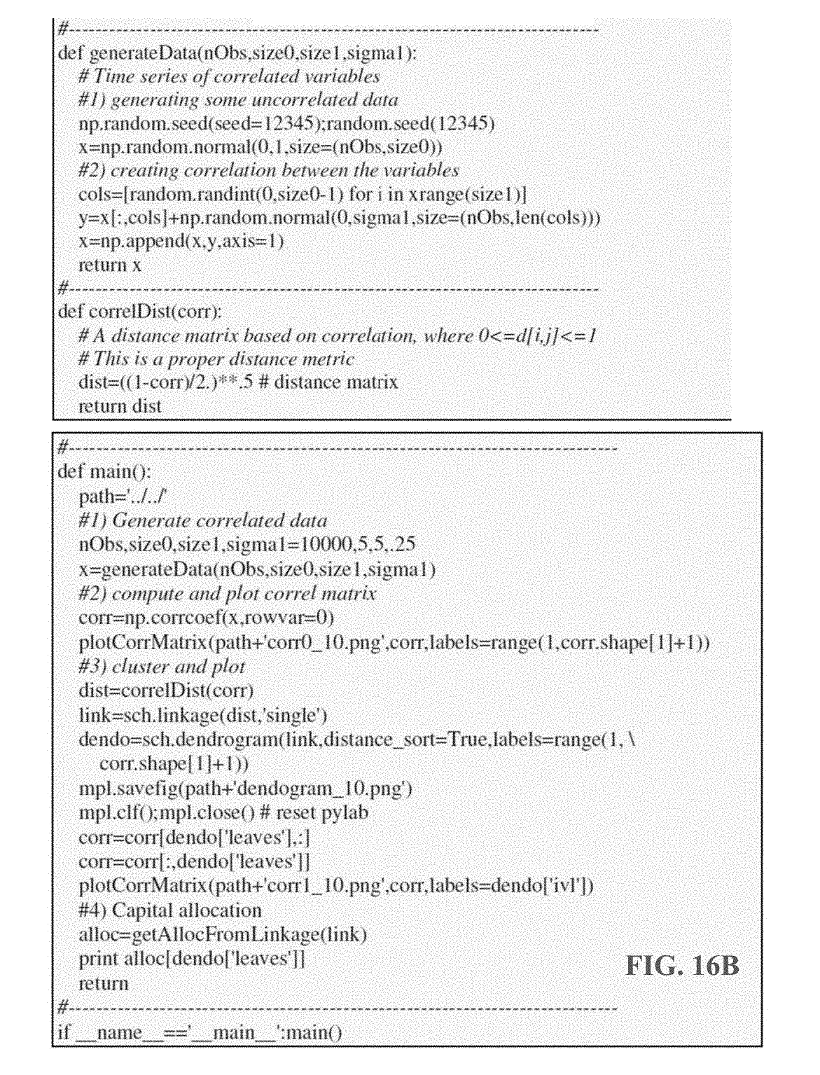

FIG. 14 depicts an exemplary dendogram of the resulting clusters. FIG. 15 is another representation of the correlation matrix of FIG. 13, reorganized in blocks according to the identified clusters. FIGS. 16A and 16B depict exemplary computer code that, when executed by the machine learning processor 208, achieves the correlation matrix and clustering processes described above.

Each machine learning processor 208 then executes the allocation algorithm introduced above, which results in weights: w₉=0.139379, w₂=0.124970, w₁₀=0.124970, w₁=0.112988, w₇=0.112988, w₃=0.085953, w₆=0.085953, w₄=0.087444, w₅=0.067176, w₈=0.067176. One of the strengths of HCA is that the numerical solution can be rationalized by looking at the three earlier plots:
The first major allocation is between items {9,2,10} on one hand and items {1,7,3,6,4,5,8} on the other. The distance between these two major groups is 1.26997, which relative to the maximum possible distance of \sqrt{10} results in a=0.4016. This means that about 40% of the weight is going to be equally split between these two major groups, and about 60% as a proportion of their relative sizes ( 3/10, 7/10). The result is that items {9,2,10} receive 38% of the total allocation, and items {1,7,3,6,4,5,8} receive the remainder 62%.
If the processor 208 descends one level in the hierarchy, the processor finds a split between {9} and {2,10}. The distance between these two is very small, only 0.179899, which gives an a=0.056889. Thus, about 94% of that suballocation is determined by the relative sizes of these clusters, resulting in very similar weights among the three items.
The next major split is between {1,7} on one hand and {3,6,4,5,8} on the other, with a distance of 1.165123, which gives an a=0.368444. Should that distance have been lower, all those items would have received a very similar allocation. But at this distance the processor must still differentiate between {1,7} and {3,6,4,5,8}, giving somewhat greater individual allocations to the former compared to the latter. Still, note that subset {1,7} received an aggregate allocation of 22.6%, while {3,6,4,5,8} received 39.4%.

The long distance between {1,7} and {3,6,4,5,8} is similar to the long distance between {3,6} and {4,5,8}. This does not mean, however, that {1,7}, {3,6} and {4,5,8} should receive similar weights. The reason is, {1,7} is far away from {3,6, 4,5,8}, hence allocations should be split between the two blocks. In turn {3,6} is far away from {4,5,8}, and the {3,6, 4,5,8} allocation should be split between {3,6} and {4,5,8}. For {1,7}, {3,6} and {4,5,8} to receive similar allocations, the distance between {1,7} and {3,6} should have been small and similar to the distance between {3,6} and {4,5,8}. That is the situation in the cluster {9,2,10}, and the reason these three items have very similar weights.

Comparison with Quadratic Optimization

The following section compares the HCA technique described herein to the CLA technique, under the standard constraints that 0≦wᵢ≦1, ∀i=1, . . . , N, and Σᵢ₌₁^{N}wᵢ=1 (for an implementation of CLA, see Bailey, D. and M. Lopez de Prado, “An open-source implementation of the critical-line algorithm for portfolio optimization,” Algorithms, Vol. 6, No. 1 (2013), pp. 169-196 (available at http://ssrn.com/abstract=2197616), which is incorporated herein by reference). Applying the covariance matrix in the above numerical example, each machine learning processor 208 has computed CLA's minimum variance portfolio (the only portfolio of the efficient frontier that does not depend on returns' means) and the inverse-volatility portfolio, characterized by

$${w}_{i} = \frac{1}{{V}_{i , i} {\sum }_{i = 1}^{I} \frac{1}{{V}_{i , i}}}$$

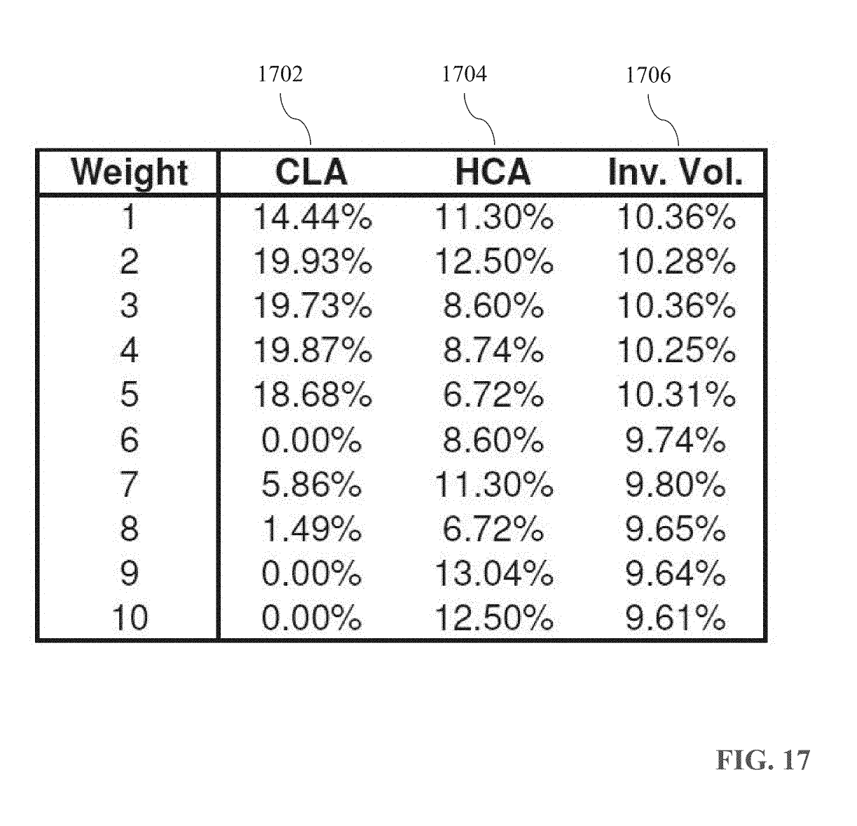

FIG. 17 depicts the different allocations from these three portfolio strategies—the CLA portfolio strategy 1702, the HCA portfolio strategy 1704, and the inverse-volatility portfolio strategy 1706. A few notable differences can be appreciated between the resulting weights from these portfolio strategies: First, CLA concentrates 92.66% of the allocation on the top-five holdings, while HCA concentrates only 60.63%. Second, CLA assigns zero weight to three investments (without the 0≦wᵢ≦1 constraint, the allocation would have been negative). Third, HCA seems to find a compromise between CLA's concentrated solution and the inverse-volatility allocation. As mentioned above, the code depicted in FIG. 17 can be used to verify that these findings generally hold for alternative covariance matrices.

What drives this extreme concentration is CLA's goal of minimizing the portfolio's risk. And yet both portfolios have a very similar standard deviation (σ_{HCA}=0.506363, σ_{CLA}=0.448597). So CLA has discarded half of the investment universe in favor of a minor risk reduction. The reality of course is, CLA's portfolio is deceitfully diversified, because any distress situation affecting the five chosen investment will have a much greater negative impact on CLA's than HCA's portfolio.

### CONCLUSIONS

Although mathematically correct, quadratic optimizers in general, and Markowitz's CLA in particular, are known to deliver generally unreliable solutions due to their instability, concentration and opacity. The root cause for these issues is that quadratic optimizers require the inversion of a covariance matrix. Markowitz's curse is that precisely when we need a diversified portfolio (in the presence of correlated investments), the less numerically stable is the matrix's inverse.

As mentioned above, a major source of quadratic optimizers' instability is: A matrix of size N is associated with a complete graph with ½N(N+1). With so many edges connecting the nodes of the graph, weights are allowed to rebalance with complete freedom. This lack of hierarchical structure means that small changes in the returns series will lead to completely different solutions. HCA replaces the covariance structure with a tree structure, accomplishing three goals: a) Unlike some risk-parity methods, it fully utilizes the information contained in the covariance matrix, b) weights' stability is recovered and c) the solution is intuitive by construction. The algorithm converges in deterministic linear time.

Of course, HCA's solution is suboptimal in CLA terms (and CLA's solution is suboptimal in HCA terms). But since CLA's solutions often underperform the naïve 1/N allocation, “optimality” may not mean much in practical terms. HCA combines covariance information with the user preferences, views and constraints encoded in the top-down allocation algorithm.

Although this application has focused on portfolio construction, it should be appreciated that HCA can be used for other practical applications, particularly in the presence of a nearly-singular covariance matrix: such as capital allocation to portfolio managers, allocations across algorithmic strategies, bagging and boosting of machine learning forecasts, and the like. For example, as portfolio must be rebalanced over time, the methods and systems described herein can be used to compute, e.g., a trade size that allows an investor to acquire the risk/return optimal position.

The HCA methodology described herein is robust, visual and flexible, allowing the user to introduce constraints or manipulate the tree structure without compromising the algorithm's search. These properties are derived from the fact that HCA does not require covariance invertibility. In fact, HCA can compute a portfolio on an ill-degenerated or even a singular covariance matrix, an impossible feat for quadratic optimizers.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more specialized processors executing a computer program to perform functions by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computer in communication with a display device, e.g., a CRT (cathode ray tube), plasma, or LCD (liquid crystal display) monitor, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the technology may be embodied in other specific forms without departing from the spirit or essential characteristics thereof. The foregoing embodiments are therefore to be considered in all respects illustrative rather than limiting of the technology described herein.

What is claimed is:

1. A system comprising:
a cluster of server computing devices communicably coupled to each other and to a database computing device, each server computing device having one or more machine learning processors, the cluster of server computing devices programmed to:
a) receive a matrix of observations;
b) divide the matrix of observations into a plurality of input data sets and transmit each of the plurality of input data sets to a corresponding machine learning processor;
c) generate, by each machine learning processor, a first data structure for a distance matrix based upon the corresponding input data set, the distance matrix comprising a plurality of items;
d) determine, by each machine learning processor, a distance between any two column-vectors of the distance matrix;
e) generate, by each machine learning processor, a cluster of items using a pair of columns associated with the two column-vectors;
f) define, by each machine learning processor, a distance between the cluster and unclustered items of the distance matrix;
g) update, by each machine learning processor, the distance matrix by appending the cluster and defined distance to the distance matrix and dropping clustered columns each rows of the distance matrix;
h) append, by the machine learning processor, one or more additional clusters to the distance matrix by repeating steps e)-g) for each additional cluster;
i) generate, by each machine learning processor, a second data structure for a linkage matrix using the clustered distance matrix;
j) analyze, by each machine learning processor, the linkage matrix to determine a number of items per cluster;
k) analyze, by each machine learning processor, the linkage matrix to assign a weight to each cluster based upon a distance of the cluster to other clusters and a size of the cluster;
l) generate, by each machine learning processor, a third data structure containing the clusters and assigned weights; and
m) consolidate each third data structure from each machine learning processor into a hierarchical data structure and transmit the hierarchical data structure to a remote computing device.

2. The system of claim 1, wherein generating a first data structure for a distance matrix further comprises:
generating a correlation matrix based upon the corresponding input data set;
defining a distance measure using the correlation matrix; and
generating the first data structure based upon the correlation matrix and the distance.

3. The system of claim 1, wherein the distance between any two column-vectors of the distance matrix comprises a Euclidian distance.

4. The system of claim 1, wherein the distance between the cluster and unclustered items of the distance matrix is determined using a nearest point algorithm.

5. The system of claim 1, wherein analyzing the linkage matrix to determine a number of items per cluster further comprises:
assigning a unit size to each item; and
determining a size of each cluster based upon the unit size assigned to each item in the cluster.

6. The system of claim 5, wherein analyzing the linkage matrix to assign a weight to each cluster further comprises:
assigning an equal weight to clusters that are separated by a distance that falls below a predetermined threshold; and
assigning a weight that is proportional to the size of each cluster where the clusters are separated by a distance that falls above a predetermined threshold.

7. The system of claim 1, wherein the remote computing device uses the weights in the hierarchical data structure to rebalance an asset allocation for a financial portfolio.

8. The system of claim 1, wherein each server computing device includes a plurality of machine learning processors, each machine learning processor having a plurality of processing cores.

9. The system of claim 1, wherein each processing core of each machine learning processor receives and processes a portion of the corresponding input data set.

10. A method comprising:
a) receiving, by a cluster of server computing devices communicably coupled to each other and to a database computing device and each server computing device comprising one or more machine learning processors, a matrix of observations;
b) dividing, by the cluster of server computing devices, the matrix of observations into a plurality of input data sets and transmit each of the plurality of input data sets to a corresponding machine learning processor;
c) generating, by each machine learning processor, a first data structure for a distance matrix based upon the corresponding input data set, the distance matrix comprising a plurality of items;
d) determining, by each machine learning processor, a distance between any two column-vectors of the distance matrix;
e) generating, by each machine learning processor, a cluster of items using a pair of columns associated with the two column-vectors;
f) defining, by each machine learning processor, a distance between the cluster and unclustered items of the distance matrix;
g) updating, by each machine learning processor, the distance matrix by appending the cluster and defined distance to the distance matrix and dropping clustered columns and rows of the distance matrix;
h) appending, by each machine learning processor, one or more additional clusters to the distance matrix by repeating steps e)-g) for each additional cluster;
i) generating, by each machine learning processor, a second data structure for a linkage matrix using the clustered distance matrix;
j) analyzing, by each machine learning processor, the linkage matrix to determine a number of items per cluster;
k) analyzing, by each machine learning processor, the linkage matrix to assign a weight to each cluster based upon a distance of the cluster to other clusters and a size of the cluster;
l) generating, by each machine learning processor, a third data structure containing the clusters and assigned weights; and
m) consolidating the third data structure from each machine learning processor into a hierarchical data structure and transmitting the hierarchical data structure to a remote computing device.

11. The method of claim 10, wherein generating a first data structure for a distance matrix further comprises:
generating a correlation matrix based upon the corresponding input data set;
defining a distance measure using the correlation matrix; and
generating the first data structure based upon the correlation matrix and the distance.

12. The method of claim 10, wherein the distance between any two column-vectors of the distance matrix comprises a Euclidian distance.

13. The method of claim 10, wherein the distance between the cluster and unclustered items of the distance matrix is determined using a nearest point algorithm.

14. The method of claim 10, wherein analyzing the linkage matrix to determine a number of items per cluster further comprises:
assigning a unit size to each item; and
determining a size of each cluster based upon the unit size assigned to each item in the cluster.

15. The method of claim 14, wherein analyzing the linkage matrix to assign a weight to each cluster further comprises:
assigning an equal weight to clusters that are separated by a distance that falls below a predetermined threshold; and
assigning a weight that is proportional to the size of each cluster where the clusters are separated by a distance that falls above a predetermined threshold.

16. The method of claim 10, wherein the remote computing device uses the weights in the hierarchical data structure to rebalance an asset allocation for a financial portfolio.

17. The method of claim 10, wherein each server computing device includes a plurality of machine learning processors, each machine learning processor having a plurality of processing cores.

18. The method of claim 17, wherein each processing core of each machine learning processor receives and processes a portion of the corresponding input data set.

19. A computer program product, tangibly embodied in a non-transitory computer readable storage device, the computer program product comprising instructions that when executed, cause a cluster of server computing devices communicably coupled to each other and to a database computing device, each server computing device comprising one or more machine learning processors, to:
a) receive a matrix of observations;
b) divide the matrix of observations into a plurality of input data sets and transmit each one of the plurality of input data sets to a corresponding machine learning processor;
c) generate, by each machine learning processor, a first data structure for a distance matrix based upon the corresponding input data set, the distance matrix comprising a plurality of items;
d) determine, by each machine learning processor, a distance between any two column-vectors of the distance matrix;
e) generate, by each machine learning processor, a cluster of items using a pair of columns associated with the two column-vectors;
f) define, by each machine learning processor, a distance between the cluster and unclustered items of the distance matrix;
g) update, by each machine learning processor, the distance matrix by appending the cluster and defined distance to the distance matrix and dropping clustered columns and rows of the distance matrix;
h) append, by each machine learning processor, one or more additional clusters to the distance matrix by repeating steps e)-g) for each additional cluster;
i) generate, by each machine learning processor, a second data structure for a linkage matrix using the clustered distance matrix;
j) analyze, by each machine learning processor, the linkage matrix to determine a number of items per cluster;
k) analyze, by each machine learning processor, the linkage matrix to assign a weight to each cluster based upon a distance of the cluster to other clusters and a size of the cluster;
l) generate, by each machine learning processor, a third data structure containing the clusters and assigned weights; and
m) consolidate each third data structure from each machine learning processor into a hierarchical data structure and transmitting the hierarchical data structure to a remote computing device.
